(19) United States
(12) Patent Application Publication
(10) Pub. No.: US 2005/0108526 A1
(43) Pub. Date: May 19, 2005

(54) Query server system security and privacy access profiles

(76) Inventor: Gavin Robertson, Arlington, TX (US)

Correspondence Address: HOWISON & ARNOTT, L.L.P, P.O. BOX 741715, DALLAS, TX, 75374-1715, US

(21) Appl. No.: 10/915,999

(22) Filed: Aug. 11, 2004

Related U.S. Application Data
(60) Provisional application No. 60/494,178, filed on Aug. 11, 2003.

(51) Int. Cl. H04L 9/00

(52) U.S. Cl. 713/166

(57) ABSTRACT

A method of controlling graduated access to data resources within an organization may be performed by assigning security access privileges to organizational roles. When a query is received, the organizational role is associated with the query source. The security access privileges are used to determine the available query data results for the organizational role. Results are provided to the query source based on the security access privileges.

### CROSS-REFERENCE TO RELATED APPLICATIONS

This application claims priority on U.S. Provisional Application 60/494,178 filed Aug. 11, 2003.

### TECHNICAL FIELD OF THE INVENTION

This invention relates to the field of access control particularly access control to data sources within graduated organizations.

### BACKGROUND OF THE INVENTION

Any comprehensive security and privacy model covers authentication, security, privacy, integrity and accountability. Authentication identifies a user, device, process, data set or system in accordance with an accepted protoco. An authentication process may verify that a user is who they say they are. Security and privacy ensure that data is not misused, disclosed to unauthorized people and protects personal identities as far as possible. Security controls access to, or use of, a device, process, data set or system. Privacy is a subset of security, and controls access to, or use of, data that is sensitive to a user or organization. Integrity provides assurances that data or processes have not be tampered with, i.e., improperly modified or duplicated. Accountability allows tracking operations, including data or system use. Accountability should be generally irrefutable.

Secure virtual private networks (VPN)s are used to provide isolated secure computing and communication environments. For government security, security level VPNs may include such level designations as unclassified, classified, secret and top secret. Furthermore, there may be sub-levels of security access defined within these secure VPNs. A user's access is generally defined by the level of clearance, such that a user on a higher security level VPN may access a lower level VPN, but a user on a lower security level VPN cannot access a higher security level VPN. Other rules may also serve to limit user access and user data manipulation.

Privacy is often a necessary requirement of any system. Depending on the jurisdiction, particularly the rules specific to that jurisdiction, privacy may be mandated for specific types of data and information. In the US, medical information is subject to severe restriction. In Europe, consumer data is strictly protected. A system needs to be adaptable to different types of information used in different locations.

In general, there is overlap between security and privacy issues. If the appropriate security is in place, privacy is less difficult to deal with. A case in point is, if genuine role-based security is in place and operates at all levels (query organization, user, application, data source organization, and data source), AND audit logs are archived, audited and analyzed, there should be accountability and significantly less abuse than if carte blanche data access is allowed. Role-based Access Control (RBAC) allows data and information to be used for specific application purposes—no more. Data and information becomes available only on an “as needed” basis.

Typically, current identity authentication requires a system-level logon and application-level logon. These logons usually involve a user name and password, which tends to be an accepted low-level security solution WITHIN organizations, but is not well accepted BETWEEN organizations or parts of organizations. There are various ways to approach this issue, most of which involve some form of digital certificate, such as Public Key Infrastructure (PKI) for SSL; however, at some point, either the query server that issues the query, the query server that executes the query, or both, will have to authenticate the identity of the person requesting the data. This ID control could be passed through (a) normal communications with SSL, (b) secure Web Services protocol, e.g., WS-Trust or SAML (Security Assertion Markup Language), or (c) some other means. Any of these methods would fit most federated query server-based systems well.

It is envisioned that there will be inter-organization security clearances in the long-term, but in the short to medium-term; a query server system will have to use some commonly accepted security clearances and access controls for the sole purpose of information sharing.

### SUMMARY OF THE INVENTION

A method of controlling graduated access to data resources within an organization may be performed by assigning security access privileges to organizational roles. When a query is received, the organizational role is associated with the query source. The security access privileges are used to determine the available query data results for the organizational role. Results are provided to the query source based on the security access privileges.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an information processing system;

FIG. 2 illustrates a flowchart of a method to perform a query on an information processing system;

FIG. 3 illustrates a flowchart of a role-based security access control system query; and

FIG. 4 illustrates a

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

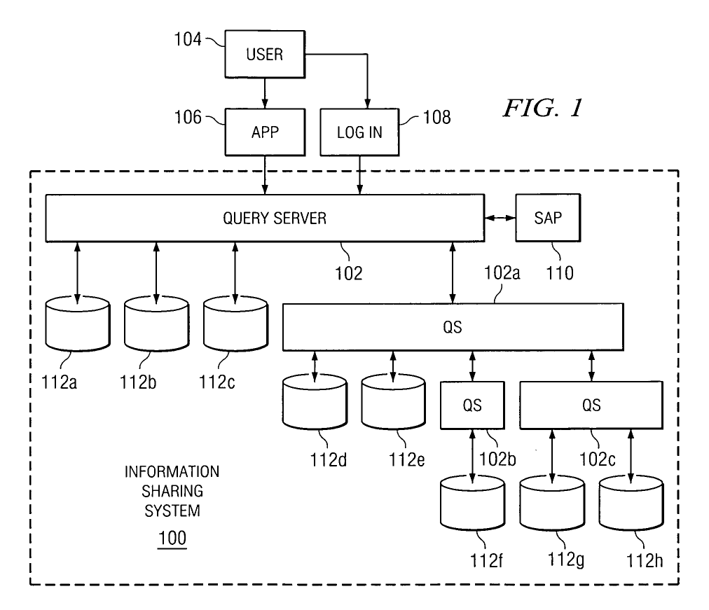

With reference to FIG. 1, an information sharing system 100 serves information to an organization from data sources 112, in response to queries. A query organization may be connected to the information sharing system 100. A user 104 belonging to the query organization may have organizationally assigned security access privileges 110. The privileges 110 may be assigned to individuals or to the roles the individuals play in an organization with specific privileges assigned to specific organizational roles. A user 104 having dual organizational roles may have access to different privileges when logged into the system in each of the roles. When the user 104 logs onto the system 108, the user 104 may be recognized by the system and accorded predetermined security access privileges 110.

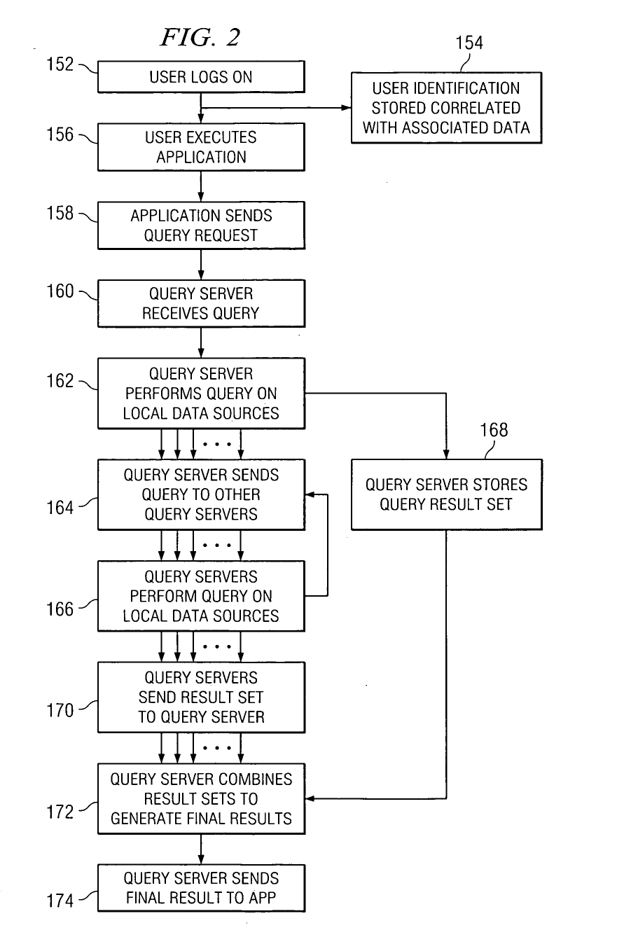

With reference to FIG. 2, a process for executing a query on a query-server system is shown. The user 104 logs onto the system 108 at function block 152. User identification information is typically stored at the local terminal or a host server at function block 154. User identification information may also be sent to a query server. The user 104 uses an application 106 at function block 156. The application 106 sends a query request to a query server 102 at function block 158. The query requests information from the information sharing system 100. The application 106 sends the query to a query server 102 associated with the information sharing system 100. The query server 102 receives the query at function block 160. The query server 102 processes the query against data sources 112 attached to the query server 102 at function block 162. Depending on the query and the architecture of the information sharing system 100, the query server 102 may pass the query on to other query servers 102 a in the information sharing system 100 at function block 164. The query server 102 may also pass the query to other query servers 102 a without performing the query, where there is no appropriate data source 112 to query associated with the query server 102.

The initial query server 102 and subsequent query servers 102a, 102b 102c may be assigned a hierarchy and linked hierarchically so that lower level query servers receive the query from the higher level query server. Each of the query servers 102 process the query against their attached data sources 112 and/or pass the query on to the lower level query servers. This continues until all query servers 102 and attached data sources 112 have considered the query and, when appropriate, processed the query. The query servers 102 and attached data sources 112 that make up the information sharing system 100 may be located in different, often remote, locations and controlled by different organizations.

The queries processed over the data sources generate results which are stored at function block 168. The query results from the lower-level query servers 102a, 102b and 102c are sent to query server 102. The query results from each data source 112 are collected by the query servers 102 to form a query server result-set. The query server result-sets from each query server 102 are combined as they are passed from lower-level query servers to the higher level query servers to form a final result-set at function block 172. Ultimately the application that submitted the query is provided the final result-set at function block 174.

Any metadata associated with a query is passed along with the query, and any metadata associated with results is passed back with the results. Such metadata includes information about the query organization and user (including security), along with query processing rules, result sort and merge rules, and other metadata. We assume a system including accepted metadata standard fields used to request data and for query modification terms.

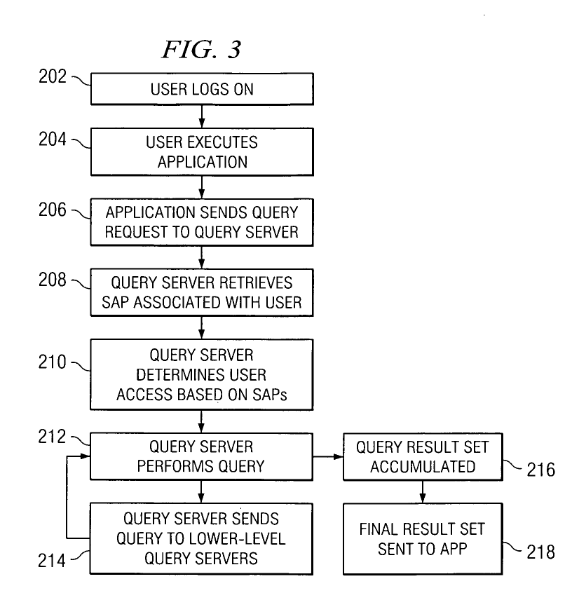

With reference to FIG. 3, a role-based security and access control process is shown. Query servers 102 can use security and privacy access profiles (SAP) 110 to accommodate various access privileges with an role based security and access control approach, depending on situational parameters such as the security level of the user 104 within a particular organization submitting the query, the application 106 that the user 104 is using to submit the query, restrictions on the combination of data requested, any overriding rule defined by the data source organization.

A user 104 logs on 108 a terminal connected to an information sharing system 100. The user 104 typically logs on 108 in a defined oganizational role, so that logging on as the treasurer of an organization always has the same access capability regardless of what individual is the treasurer. The user 104 executes an application 106 at function block 204. In the course of execution, the application 106 sends a query request to a query server 102 at function block 206. The query server 102 retrieves the security access permissions associated with the user 104 at function block 208. The query server 102 determines the access limits for the user based on the SAPs at function block 210. Within the determined access limits, the query server 102 performs the query at function block 212 and sends the query to lower level query servers at fucntion block 214. The query results are accumulated at function block 216. The final results are then returned to the application 106 at function block 218.

A role-based security and access control process may use a variety of security and privacy access profile types. A query organization access profile (QOAP) pecifies what metadata standard fields are available to be accessed by a particular organization. A query organization access profile may be modified by subsequent security and privacy access profiles.

A user access profile (UAP) specifies what metadata standard fields can be accessed by a particular user and this may depend on the data source, e.g., can only see personal information from own internal data sources, but not other external data sources.

An application access profile (AAP) specifies what combinations of metadata standard fields are permitted for a particular application, e.g., may not be allowed to see full name, social security number, IRS data, AND credit history combined, but only some of the data can be provided. This may be user-dependent, i.e., a higher security level user may be able to see this information combined.

A content access profile (CAP) specifies what content is permitted to the user. For example, a user may be cleared to look at data in their state, or at recent data, but not at data for other states or past data.

A data source access profile (DSAP) specifies what metadata standard fields can be accessed from a particular data source.

A data source oganization access profile (DSOAP) resides on the data source and specifies what standard data fields are available to a particular query organization. This pertains directly to the agreement/relationship between the query organization and the data source organization. There may be different DSOAPs depending on user security levels.

Of the above security and privacy access profiles, a content access profile is different from the other access profiles because it is implemented through query modification terms rather than the Boolean inclusion or exclusion of metadata standard fields. The default is typically exclusion rather than inclusion. Unless an security and privacy access profile specifically includes a metadata standard field, it will be excluded from the query and/or result-set, depending on the type of security and privacy access profile.

Security and privacy access profiles in conjunction with a query system that exerts 100% control over how queries are executed can prevent unauthorized data from being requested. Other query systems that have to filter result-sets to fulfill queries must first request unauthorized data and then filter out unauthorized data, leaving only authorized data. Obviously, the former is better than the latter from a security and privacy point-of-view.

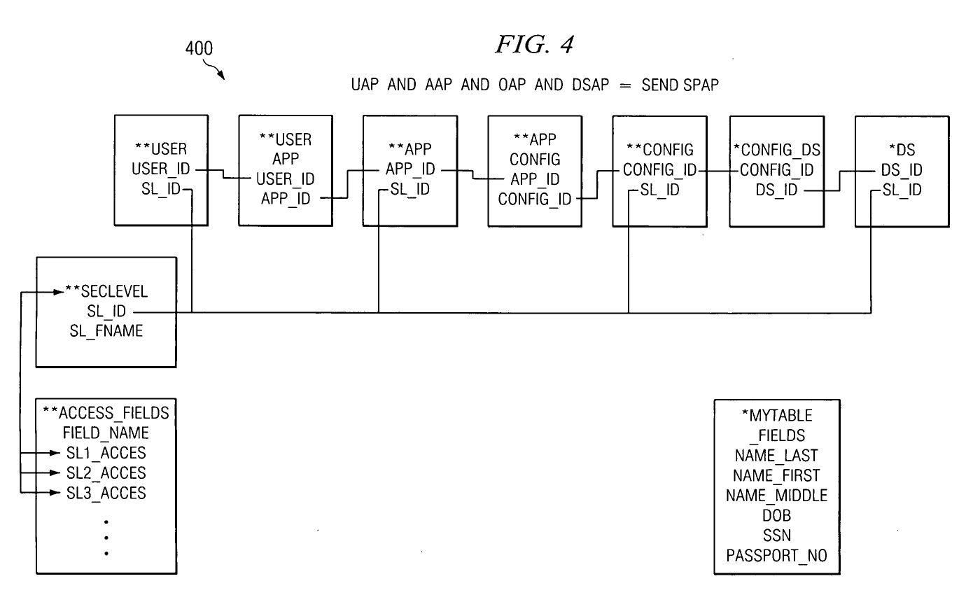

With reference to FIG. 4, a schema of the following query 400 is shown. Ultimately, a Boolean sum of security and privacy access profiles is executed and applied to the query virtual table or query virtual database, called Superschema™, containing metadata standard fields being sought in a query, as follows:

To a specific data source and therefore organization: QOAP AND UAP AND AAP AND DSAP=Send SPAP. The “Send SPAP” is the Superschema that's sent from a query organization to a specific data source and therefore data source organization.

At the specific data source and for a specific query organization/data source organization relationship: Send SPAP AND DSOAP=Receive SPAP. The “Receive SPAP” is the Superschema that's ultimately used to define what metadata standard field results are returned to a user from a specific data source and therefore data source organization.

In addition to the Boolean inclusion and exclusion SPAPs above, the query may be modified to accommodate content access profiles (CAPs) and combinations of data.

A SQL SELECT query statement submitted by an application to a query server system may consist of two major components. There is a table or tables from which data is being requested. There are query modification terms, e.g., where NAME_LAST=“Smith” and DOB between ‘1-1-1955’ and ‘1-1-1965’

A relational database schema may accommodate the SPAPs associated with inter-organization data and information integration and sharing. The SPAPs are based on registered data source organizations, registered users, registered applications, registered data source organizations, and registered data sources.

This relational database schema can also accommodate combinations of data from a query request point-of-view, by excluding Superschema metadata standard fields in the access profiles. For example, if someone asks to include name and SSN in the result-set, but they are not entitled to see both pieces of information together, the name OR the SSN can be requested, but not both together. More complex rules on combinations of data may implemented.

The relational database schema can also be extended to accommodate query term modifications. For example, a user can search for approved metadata standard fields, but only in the state of Texas—an extra query term would have to be added to the query as follows: “where STATE=“TX””; or only on US Citizens: “where NATIONALITY=“US””.

With reference to FIG. 4, note that the diagram does not follow standard ER relational database notation; the arrows are used to represent a relation that is not an ER relation. Field SL_FNAME in table SECLEVEL contains the field names (SL1_ACCESS, SL2_ACCESS and so on) to use when querying on **ACCESS_FIELDS table.

Restricting data access through role-based security access control (RBAC) systems provides ready solutions to the situation where a user attempts to access data that is not necessary for the user's authorized purpose. This allows the system to control data so that access to each specific element data can be strictly limited to authorized accesses.

The role-based security access control system may inform a user that results of a query are available, but not to provide the actual results to the user until some higher-level permission is obtained. An interim stage may be available where the user can be provided with the number of records isolated in query servers with a query, without any direct contact with a data source and without retrieving source data.

When indexes are built and maintained, sensitive data can be either encrypted or replaced with an alias. Likewise, once isolated, retrieved sensitive data can be either encrypted or aliased.

Data sources typically have their own integrity assurance systems. Assurances about the integrity of the query server queries, queries including metadata, indexes, result-sets, and result-sets including metadata can be provided for with a role-based security access control system. Implementing SSL or some other secure system could solve most integrity issues associated with

Role based security access control systems in combination with good security and privacy access controls, such as SPAPs, provide an approach for a controlling access in federated data and information sharing system using query servers. Many of the privacy issues are managed by role-based security access control systems, including restricting access to an “as needed” basis for data and information requests.

Query server based information sharing systems can record every single query operation, including metadata about the query and results provided, in an audit log. Actual result-sets could also be stored, although this introduces other security and privacy issues. Routine analysis could be run against, or intelligent software agents could monitor, audit logs to catch potential misuse very shortly after it occurs. Intelligent audit agents running on query servers themselves could also monitor and possibly prevent misuse before it occurs.

A query server-based information sharing system platform provides a universal and uniform means of imposing security and privacy access profiles with queries and result-sets, and is flexible enough to accommodate almost any standards, including Web Services standards.

Query servers address the four aspects of a comprehensive security and privacy system effectively, and in particular security and privacy access through SPAPs. Query servers currently communicate with other query servers through sockets, which allows for currently widely accepted SSL secure communications, plus, identity authentication systems such as enterprise PKI can already be used with query servers. Other options for identity authentication, such as SOAP/XML standards, can be easily incorporated.

Controlling access at all levels in a federated data and information integration and sharing system remains a complex matter. Query servers offer a platform that can accommodate most, if not all, of the aspects through the SPAPs comprehensive relational database schema that is flexible enough to accommodate future options.

A secure system goes a long way to protecting the integrity of system traffic and files located on the system. There are also other options for additional integrity protection.

Audit logs that are actively monitored and analyzed are key to assuring accountability. Also, intelligent agents running on the audit logs or query servers could potentially catch misuse shortly after it happens or prevent it in the first place.

An query server communicates with other query servers in a hierarchical structure, using peer-to-peer communication, through sockets, RPC or Java RMI. Socket communication will typically be done using secure socket layer (SSL) protocols. Using a Web Services paradigm, any metadata associated with a query is passed along with the query, and any metadata associated with the results is passed back with the results. Proprietary formats may be used, including a Web Services model using XML for the file format. Metadata associated with the query organization and user, including security, along with query processing rules, result sort and merge rules and other metadata will be passed to and back from external index query servers.

In general, there is an overlap between security and privacy issues. If the appropriate security systems are in place, most privacy issues are relatively easy to deal with. For example, if a genuine role-based security is in place and operates at all levels, including query organization, user, application, data source organization and data source, and audit logs are archived, audited and analyzed, acceptable levels of accountability should be present. This should result in significantly less abuse than a system with carte blanche data access allowed. Role-based security access control allows data and information to be used for specific application purposes and nothing else. Data and information becomes available only on an “as needed” basis. Ideally, any data or information that is retrieved should be assigned a self managed and executed shelf-life, such that the retrieved instance of the data is deleted automatically or somehow expires after it has been used for a specific, designated purpose so that it cannot be used for any purpose after the expiration.

In the context of this model, the term “data” refers to information in a database. Information is more general, including unstructured text as well as data. In most cases, the terms will be used interchangeably.

Typically, authentication of a user will require a system-level logon and an application-level logon. The logon protocols usually require a user name and password. This type of authentication provides a relatively low level of security within an organization. However, the logons will not generally be accepted between organizations or often between divisions within an organization.

To accomplish inter-organization authentication, there are a variety of protocols in use. Most of these protocols involve some form of digital certificate such as public key infrastructure (PKI) for SSL. The external index query server that issues a query or the external index query server that executes the query, or both, will have to authenticate the identity of the user requesting the data. This authentication could be passed through normal communications using SSL, secure Web Services protocols such as WS-Trust or security assertion markup language (SAML) or other, typically less expensive, means.

Universally accepted security clearances would simplify the implementations, but for the present any system should recognize multiple, different security clearances and access controls.

Query servers use security access profiles (SAP) to accommodate various access privileges with a role-based security access control approach. These may depend on the security level of the user, within a particular organization, submitting the query. They may depend on the application that the user is using to submit the query. They may depend on the combination of data requested. Decisions by the data source organization are also considered.

It will be appreciated by those skilled in the art having the benefit of this disclosure that this invention provides a role-based security access control system. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A method of controlling graduated access to data resources within an organization comprising the steps of:
assigning security access privileges to organizational roles;
receiving a query
determining an organizational role associated with a query source;
determining the availability of query data results in accordance with the security access privileges for the organizational role;
providing results to said query source based on said security access privileges.

2. The method of claim 1, wherein said organization is a governmental organization.

3. The method of claim 1, wherein said organization is a commercial organization.

4. The method of claim 1 wherein said security access privileges include unclassified, classified secret and top-secret levels.

5. The method of claim 1 wherein said security access privileges comprise a query organization access profile.

6. The method of claim 1, wherein said security access privileges comprise a user access profile.

7. The method of claim 1, wherein said security access privileges comprise an application access profile.

8. The method of claim 1, wherein said security access privileges comprise a content access profile.

9. The method of claim 1, wherein said security access privileges comprise a data source access profile.

10. The method of claim 1, wherein said security access privilege comprise a data source organization access profile.

11. A system for enforcing graduated security access control to data in a data source within an organization comprising:
a query source, wherein said query source is assigned a role;
a security access profile associated with said role;
a query server connected to said query source; and
a data source connected to said query source;
wherein said query server provides query results to said query source according to restrictions based on said security access profile.

12. The system of claim 11, wherein said organization is a governmental organization.

13. The system of claim 11, wherein said organization is a commercial organization.

14. The system of claim 11 wherein said security access privileges include unclassified, classified secret and top-secret levels.

15. The system of claim 11 wherein said security access privileges comprise a query organization access profile.

16. The system of claim 11, wherein said security access privileges comprise a user access profile.

17. The system of claim 11, wherein said security access privileges comprise an application access profile.

18. The system of claim 11, wherein said security access privileges comprise a content access profile.

19. The system of claim 11, wherein said security access privileges comprise a data source access profile.

20. The system of claim 11, wherein said security access privilege comprise a data source organization access profile.
